(19) United States
(12) Patent Application Publication
(10) Pub. No.: US 2013/0171536 A1
(43) Pub. Date: Jul. 4, 2013

(54) Fuel Cell

(71) Applicant: Air Liquide, Societe Anonyme pour Etude et Exploitation des Procedes Georges Claude, Paris (FR)

(72) Inventors: Arnaud CERCEAU, Houston, TX (US); Nicolas Jannin, Houston, TX (US); Julien Marteau, Houston, TX (US)

(73) Assignee: Air Liquide, Societe Anonyme pour Etude et Exploitation des Procedes Georges Claude, Paris (FR)

(21) Appl. No.: 13/725,496

(22) Filed: Dec. 21, 2012

(30) Foreign Application Priority Data
Jan. 3, 2012 (FR) FR 1250031

(51) Int. Cl. H01M 8/04

(52) U.S. Cl. CPC H01M 8/04029
USPC 429/437

(57) ABSTRACT

Fuel cell including several stacks of fuel cell elementary cells, at least part of the stacks being mounted in parallel and in a modular manner in order to allow the electric power level supplied by the cell to be adapted by adapting the number of stacks present in the cell, the cell including a cooling circuit including several legs in parallel for the selective cooling of said stacks by means of heat exchange, a heat-conveying liquid being selectively circulated in the cooling circuit via at least one pump, characterized in that the cooling circuit includes different pumps arranged respectively in several of said legs of the cooling circuit,

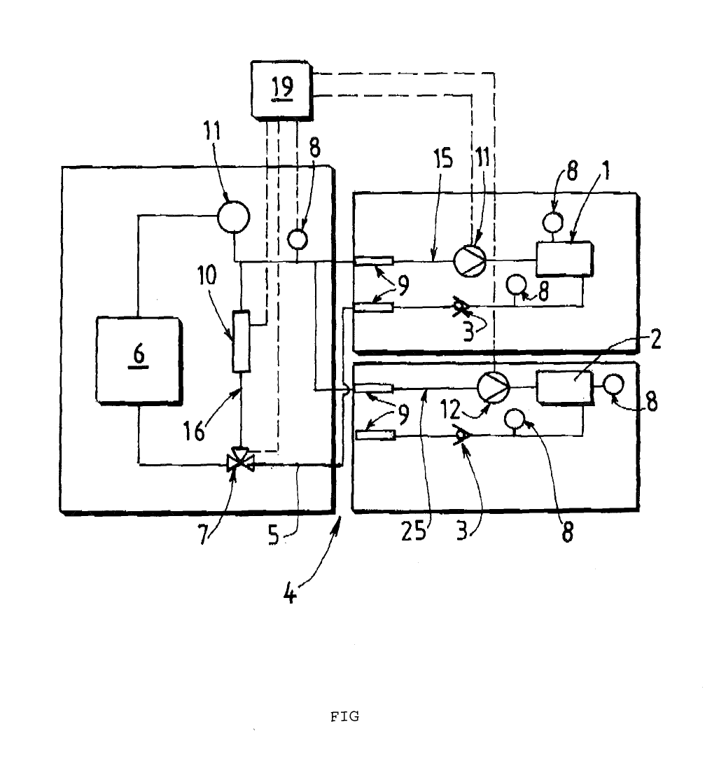

### CROSS-REFERENCE TO RELATED APPLICATIONS

This application claims the benefit of priority under 35 U.S.C. §119 (a) and (b) to French Patent Application No. FR 1250031, filed Jan. 3, 2012, the entire contents of which are incorporated herein by reference.

### BACKGROUND

1. Field of the Invention

The present invention concerns a fuel cell including several stacks of elementary cells.

More particularly, the invention concerns a fuel cell including several stacks of fuel cell elementary cells, at least part of the stacks being mounted in parallel and in a modular manner in order to allow the electric power level supplied by the cell to be adapted by adapting the number of stacks present in the cell, the cell including a cooling circuit including several legs in parallel for the selective cooling of said stacks by means of heat exchange, a heat-conveying liquid being selectively circulated in the cooling circuit via at least one pump.

2. Related Art

The architecture described above is satisfactory overall. However, the pump of the cooling circuit has to be dimensioned in order to supply all the legs of the cooling network in a satisfactory manner (each stack of cells). This means that the pump has to be dimensioned for maximum flows (maximum number of stack modules utilized at the same time). The pump delivery rates, however, are very variable within their flow range. In the case where one single stack is utilized for the cell, the pump will be used at a slow rate and its delivery rate risks being degraded. In certain situations, the pump could be incapable of supplying a flow below a certain value.

### SUMMARY OF THE INVENTION

One aim of the present invention is to alleviate all or part of the disadvantages of the prior art referred to above.

More particularly, the invention concerns a fuel cell including several stacks of fuel cell elementary cells, at least part of the stacks being mounted in parallel and in a modular manner in order to allow the electric power level supplied by the cell to be adapted by adapting the number of stacks present in the cell, the cell including a cooling circuit including several legs in parallel for the selective cooling of said stacks by means of heat exchange, a heat-conveying liquid being selectively circulated in the cooling circuit via at least one pump.

The invention notably concerns fuel cells with a modular structure. This is to say that the fuel cell is formed by elementary modules forming the principle operating elements of the cell. According to said architecture, the number of modular elements is adjusted as a function of the requirements of the application. For example, the number of elementary cell stacks can be adjusted for the cell according to the electric power required.

In a preferable manner, each modular element includes a stack of cells and its own system for supply with fuel gas (hydrogen) and oxidant (air). Each module can thus comprise its own compressor.

Other elements of the cell are shared, for example a power converter, the pump and the heat exchanger of the liquid cooling circuit.

To this end, the fuel cell according to the invention, otherwise in keeping with the generic definition given in the preamble above, is essentially characterized in that the cooling circuit includes different pumps arranged respectively in several of said legs of the cooling circuit.

Moreover, embodiments of the invention can comprise one or several of the following characteristics:
the cooling circuit comprises a respective pump in each of said parallel legs of the cooling circuit, said pumps being structurally connected to said corresponding modular stacks,
each assembly including a corresponding leg of the cooling circuit, a pump and a stack, is structurally connected in a removable casing, one end of the leg including removable rapid fluidic connection members cooperating selectively with twin members formed on part of the cooling circuit common to all of the stacks, located away from the legs,
the fluidic connection members of the leg and the twin members formed on the common part of the cooling circuit are of the automatic opening type during the fluidic connection and of the automatic closing type during the disconnection,
the cooling circuit includes a heat exchanger for the selective cooling of the heat-conveying liquid, said heat exchanger being arranged in part of the cooling circuit common to all the stacks, that is to say away from the parallel legs of the modular stacks,
the cooling circuit includes a portion for the selective by-pass of the heat exchanger and at least one valve for the selective distribution of the liquid in the by-pass portion,
the cooling circuit includes a heater for the heat-conveying liquid arranged in the portion by-passing the heat exchanger,
the cell includes electronic logic connected to the different pumps located in the parallel legs of the cooling circuit, the electronic logic being configured in order to control said pumps independently and therefore the cooling liquid flows into said parallel legs,
the legs of the cooling circuit each include a non-return valve arranged downstream of the pump and of the corresponding stack in order to prevent a flow of liquid counter to the direction of circulation of the fluid created by the pump.

The invention can also concern any alternative device or process including all combinations of the characteristics above or below.

### BRIEF DESCRIPTION OF THE FIGURES

Fig. illustrates an embodiment of the inventive fuel cell.

Other distinctive features and advantages will become obvious on reading the description hereafter, made with reference to the sole FIGURE which, in a schematic and partial manner, shows an example of the structure and possible operation of a fuel cell according to the invention.

### DETAILED DESCRIPTION OF THE INVENTION

In an attempt at simplification, the fuel cell shown in part by way of example in the FIGURE includes two stacks 1, 2 of fuel cell elementary cells. Obviously, the cell 4 can comprise more than two stacks. Each elementary cell produces electricity by reaction between the hydrogen and oxygen within an electron membrane assembly separating an anode and a cathode.

Said stacks 1, 2 are preferably mounted in a manner so as to be selectively detachable from the rest of the cell 4. Said stacks 1, 2, each of which can include its own members for managing the flows of fuel gas (hydrogen) and oxidant (air), are mounted in parallel and in a modular manner in order to allow the level of electric power supplied by the cell 4 to be adapted by adapting the number of cell stacks 1, 2.

Classically, the cell has a cooling circuit 5 including several legs 15, 25 in parallel for the selective cooling of said stacks 1, 2 by means of heat exchange. A heat-conveying liquid is selectively circulated in the cooling circuit 5.

According to an advantageous distinctive feature of the installation, the cooling circuit includes different pumps 11, 12 arranged respectively in several, and in a preferred manner in all, of the parallel legs 15, 25 of the cooling circuit 5.

Said distinctive feature allows the overall delivery rate of the system to be improved by controlling the energy consumption of the pumps 11, 12 of each of the legs 15, 25.

The cooling circuit 5 classically includes a heat exchanger 6 for the selective cooling of the heat-conveying liquid. In a preferable manner, the heat exchanger 6 is arranged in part of the cooling circuit 5 which is common to all the stacks 1, 2. This is to say that the use of the exchanger 6 is shared away from the parallel legs 15, 25 of the modular stacks 1, 2.

In a preferable manner, the respective pumps 11, 12 are structurally connected to said corresponding modular stacks 1, 2, for example in a corresponding casing including the members 9 for fluidic connection between the legs 15, 25 and the rest of the circuit 5. Said connection members 9 and their twin connections over the rest of the circuit 5 form, for example, rapid connections with two-way shutoff allowing one module to be separated off whilst allowing the rest of the circuit to operate.

As shown, each leg 15, 25 can form a loop, two ends of which are connected selectively to the rest of the circuit 5 by means of respectively two fluidic connection members 9.

Also in a preferable manner, a non-return valve 3 is arranged in each leg, downstream of the stack 1, 2 in order to allow the heat-conveying liquid to circulate in all of the circuit 5.

An expansion tank 11 is preferably provided in the circuit 5, in the common part (away from the legs 15, 25), in order to absorb the variations in the volume of the liquid.

In this way, each pump 11, 12 is integrated in its respective cell module. When a module with a stack 1, 2 is added or withdrawn in relation to the cell, the corresponding pump 11, 12 follows said stack.

The pump 11, 12 integrated into the module so as to be selectively detachable is dimensioned for the range of flow associated with said module and its delivery rate is therefore optimized as a result.

The cooling circuit 5 preferably also includes a portion 16 for the selective by-pass of the heat exchanger 6 and at least one valve 7 (for example a three-way solenoid valve) for the selective distribution or not of the liquid into the by-pass portion. As shown in the FIGURE, as an option the cooling circuit 5 can include a heater 10 for the heat-conveying liquid arranged in the portion 16 by-passing the heat exchanger 6.

The cooling circuit 5 preferably includes a temperature sensor 8 for the heat-conveying liquid of the cooling circuit 5 arranged in the common part of the circuit (away from the legs 15, 25). Obviously, other temperature sensors 8 can be provided at the level of each stack 1, 2 and/or in each leg 15, 25, for example downstream of each stack 1, 2.

The temperature gradient can be calculated according to the following formula: max(Temperature of the cell; Temperature of the cooling liquid at the outlet of the cell)−Temperature of the cooling liquid upstream of the module.

The cell or the installation including the cell 4 preferably comprises electronic logic 19 connected to the different pumps 11, 12 located in the parallel legs 15, 25 of the cooling circuit 5. The logic can also be connected to the sensor or sensors 8 and to the by-pass valve 7.

According to one advantageous distinctive feature, the electronic logic 19 can be configured to control the power of the pumps 11, 12 independently and therefore the flows of cooling liquid in said parallel legs 15, 25.

Said configuration allows the temperature gradient to be controlled and regulated within each stack 1, 2. The possible differentiation between the flows of cooling liquid in the modules makes it possible, if necessary, to develop the parameters of thermal control in real time (temperature gradient within the stack for example).

It is possible notably to imagine being able to disconnect one module (one stack) whilst all the others are active without this having any impact on the temperature control of the active stacks.

In the event of one pump failing, the module concerned can be stopped and the other modules can continue to operate.

Contrary to the systems according to the prior art, such architecture also allows freedom from the constraints of the design of a network (for example in the event of losses of different hydraulic charges in each parallel leg).

Said architecture also allows sequenced frost protection of the different stacks to be realized at the start-up of the cell in order to accelerate and/or optimize the start-up of the system at a low temperature. In particular, in the case of sequenced start-up (one stack is started up after the other), the volume of cooling liquid to be heated is less great at the start-up.

In addition, said architecture facilitates the maintenance of the cell. In fact, actions are concentrated on modules which have approximately the same maintenance intervals.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A fuel cell comprising:
several stacks of fuel cell elementary cells, at least part of the stacks being mounted electrically in parallel and in a modular manner in order to allow an electric power level supplied by the fuel cell to be adapted by adapting the number of stacks present in the fuel cell; and
a cooling circuit including several legs fluidically in parallel adapted and configured for selective cooling of said stacks by means of heat exchange with a heat-conveying liquid that is selectively circulated in the cooling circuit via at least one pump, wherein the cooling circuit comprises a respective pump in each of said several parallel legs of the cooling circuit, each one of said several pumps being structurally connected to one of said corresponding stacks.

2. The cell of claim 1, wherein:
each assembly of a corresponding cooling circuit leg, pump and stack is structurally connected in a respective removable casing; and
one end of each leg including removable rapid fluidic connection members cooperating selectively with twin members formed on part of the cooling circuit that is common to all the stacks located away from the legs.

3. The cell of claim 2, wherein the fluidic connection members of the leg and the twin members formed on the common part of the cooling circuit are of an automatic opening type when fluidically connected and of an automatic closing type when fluidically disconnected.

4. The cell of claim 1, wherein the cooling circuit includes a heat exchanger adapted and configured for selective cooling of the heat-conveying liquid, said heat exchanger being arranged in a part of the cooling circuit that is common to all the stacks away from the several parallel legs of the stacks.

5. The cell of claim 4, wherein the cooling circuit includes a portion for selective by-pass of the heat exchanger and at least one valve for selective distribution of the liquid into the by-pass portion.

6. The cell of claim 1, wherein the cooling circuit includes at least one sensor arranged in a part of the cooling circuit that is common to all the stacks away from the several parallel legs of the stacks.

7. The cell of claim 1, wherein the cooling circuit includes a portion for selective by-pass of the heat exchanger and a heater of the heat-conveying liquid arranged in the by-pass portion.

8. The cell of claim 1, further comprising electronic logic controller connected to the different pumps located in the parallel legs of the cooling circuit, the controller being adapted and configured to control said pumps independently and therefore adapted and configured to control flows of the cooling liquid into said parallel legs.

9. The cell of claim 1, wherein each of the legs of the cooling circuit includes a non-return valve arranged downstream of the pump and of the corresponding stack in order to prevent a flow of liquid counter to a direction of circulation of the fluid created by the pump.
